(19) United States
(12) Patent Application Publication
(10) Pub. No.: US 2023/0383595 A1
(43) Pub. Date: Nov. 30, 2023

(54) CELLULAR SLATS FOR A COVERING FOR AN ARCHITECTURAL STRUCTURE

(71) Applicant: Hunter Douglas Inc., Pearl River, NY (US)

(72) Inventor: Wendell B. Colson, Vineyard Haven, MA (US)

(21) Appl. No.: 18/031,757

(22) PCT Filed: Oct. 18, 2021
(86) PCT No.: PCT/US2021/055360

§ 371 Date: Apr. 13, 2023

Related U.S. Application Data
(60) Provisional application No. 63/093,870, filed on Oct. 20, 2020.

(51) Int. Cl. E06B 9/386; E06B 9/28; E06B 9/266; B32B 5/02; B32B 27/36; B32B 27/12; B32B 1/08

(52) U.S. Cl. CPC E06B 9/386; E06B 9/28; E06B 9/266; B32B 5/024; B32B 5/022; B32B 27/36; B32B 27/12; B32B 1/08; B32B 2262/02; B32B 2307/518; B32B 2597/00

(57) ABSTRACT

In one aspect, a cellular slat for a covering for an architectural structure includes an outer sock forming an outer cellular structure and an inner core configured to be positioned within the outer cellular structure. The inner core includes first and second ends and first and second fold edges formed between the first and second ends. With the inner core positioned within the outer sock, the inner core forms an inner cellular structure having a first curved profile extending along the first side of the cellular structure between the first and second fold edges and a second curved profile extending along the second side of the cellular structure between the first and second fold edges. Additionally, the inner core is in an at least partially detached state relative to the outer sock along at least a portion of an interface defined between the inner core and the outer sock.

### CROSS-REFERENCE TO RELATED APPLICATIONS

The present application is based upon and claims the right of priority to U.S. Provisional Patent Application No. 63/093,870, filed Oct. 20, 2020, the disclosure of which is hereby incorporated by reference herein in its entirety for all purposes.

### FIELD

The present subject matter relates generally to coverings for architectural structures and, more particularly, to cellular slats configured for use with light-control coverings for architectural structures.

### BACKGROUND

It is known within the industry to utilize cellular slats or vanes as covering elements within a covering for an architectural structure. For instance, conventional cellular slats have been formed in the past as a two-piece construction including an exterior shell or tube and an interior element positioned within the exterior tube. As an example, U.S. Pat. No. 6,688,373, entitled “Architectural Covering for Windows” and referred to hereinafter as the '373 patent, discloses an opaque slat for use with a blind that includes an exterior torque tube and a resilient insert strip that is inserted into the torque tube. While the insert strip of the '373 patent provides some structural integrity to the exterior torque tube, the disclosed “V,” “C”, and “S” folded configurations of the insert strip fail to generally provide adequate stiffness at both outer edges or joints of the slat. In addition, the resulting slat has an asymmetrical shape, which can often be aesthetically undesirable to consumers.

As an alternative to the use of separate insert strips as the interior element of a cellular slat, other known cellular slat configurations rely upon fully laminating the interior element to the exterior shell or tube. For example, it is known to laminate a film material to a fabric material and subsequently form such laminated fabric/film assembly into a closed-perimeter cell such that the fabric material is positioned along the exterior of the cell and the film material is positioned along the interior of the cell. With such configurations, the fully laminated fabric/film assembly is often folded or creased to form the opposed edges of the slat, with the free ends of the laminated fabric/film assembly being connected together to form the closed-perimeter cell. However, slats formed from such laminated fabric/film assemblies typically experience significant deformation, warping, and/or other thermal or stress-related issues when exposed to the high-end of the temperature range generally found in window environments.

Accordingly, an improved cellar slat configuration that addresses one or more of the issues associated with known cellular slats would be welcomed in the technology.

### BRIEF SUMMARY

Aspects and advantages of the present subject matter will be set forth in part in the following description, or may be obvious from the description, or may be learned through practice of the present subject matter.

In one aspect, the present subject matter is directed to a cellular slat for a covering for an architectural structure. The cellular slat includes an outer sock forming an outer cellular structure and an inner core configured to be positioned within the outer cellular structure of the outer sock. The inner core includes first and second ends and first and second fold edges formed between the first and second ends such that the inner core includes a plurality of wall segments. The plurality of wall segments include a base wall segment extending between the first and second fold edges of the inner core, a first folded wall segment extending between the first fold edge of the inner core and first end of the inner core, and a second folded wall segment extending between the second fold edge of the inner core and the second end of the inner core. With the inner core positioned within the outer sock, the inner core forms an inner cellular structure having opposed first and second sides extending between the first and second fold edges of the inner core, with the inner cellular structure having a first curved profile defined by the base wall segment that extends along the first side of the cellular structure and a second curved profile defined by at least one of the first folded wall segment or the second folded wall segment that extends along the second side of the cellular structure. Additionally, the inner core is in an at least partially detached state relative to the outer sock along at least a portion of an interface defined between the inner core and the outer sock.

In another aspect, the present subject matter is directed to a covering for an architectural structure that includes a plurality of cellular slats, with each cellular slat of the plurality of cellular slats generally being configured in accordance with the cellular slat described above.

In a further aspect, the present subject matter is directed to a method for manufacturing inner core structures configured for use within cellular slats. The method includes folding a strip of film material at spaced apart locations between opposed first and second ends of the film material to form first and second fold edges in the strip of film material, and forming the strip of film material into a cellular structure defining opposed first and second curved profiles extending between the first and second fold edges. In addition, the method includes heat-stabilizing the film material at the first and second fold edges while the cellular structure of the strip of material is maintained intact.

These and other features, aspects, and advantages of the present subject matter will become better understood with reference to the following Detailed Description and appended claims. The accompanying drawings, which are incorporated in and constitute a part of this specification, illustrate embodiments of the present subject matter and, together with the description, serve to explain the principles of the present subject matter.

This Brief Description is provided to introduce a selection of concepts in a simplified form that are further described below in the Detailed Description. This Brief Description is not intended to identify key features or essential features of the claimed subject matter, nor is it intended as an aid in determining the scope of the claimed subject matter.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 illustrates a perspective view of one embodiment of a covering for an architectural structure in accordance with aspects of the present subject matter, particularly illustrating the covering including a plurality of cellular slats;

FIG. 2 illustrates a perspective view of one embodiment of a cellular slat in accordance with aspects of the present subject matter;

FIG. 3 illustrates a cross-sectional view of the cellular slat shown in FIG. 2 taken about line 3-3, particularly illustrating one embodiment of a configuration for an outer sock and an inner core of the cellular slat in accordance with aspects of the present subject matter;

FIG. 4 illustrates an end view of the inner core of the cellular slat shown in FIG. 3 in a non-constrained, disassembled state, particularly illustrating first and second fold edges of the inner core along with the various wall segments extending between/from the fold edges;

FIG. 5 illustrates a cross-sectional view of one embodiment of a heat treatment apparatus or assembly that can be used to heat-set or heat-stabilize the fold edges of an inner core of a cellular slat in accordance with aspects of the present subject matter;

FIG. 6 illustrates another cross-sectional view of the cellular slat shown in FIG. 2 taken about line 3-3, particularly illustrating another embodiment of a configuration for an outer sock and an inner core of the cellular slat in accordance with aspects of the present subject matter; and

FIG. 7 illustrates a flow diagram of one embodiment of a method for manufacturing inner core structures configured for use within cellular slats in accordance with aspects of the present subject matter.

### DETAILED DESCRIPTION

In general, the present subject matter is directed to a cellular slat configured for use within a covering for an architectural feature or structure (referred to herein simply as an architectural “structure” for the sake of convenience and without intent to limit). As will be described below, the cellular slat generally includes an outer sock forming an outer cellular structure of the slat and an inner core positioned within the outer sock that forms an inner cellular structure of the slat.

In several embodiments, the inner core of the cellular slat is formed from a strip of thin-walled material (e.g., a film material) that has been twice-folded to form first and second fold edges spaced apart from one another between opposed ends of the strip of material. In such embodiments, the inner core can be formed into a closed-perimeter or substantially closed-perimeter cell having a symmetrical shape characterized by opposed curved walls that extend between the first and second fold edges of the inner core, with the fold edges generally forming opposed vertices of the inner cellular structure. Additionally, the opposed fold edges or vertices of the inner cellular structure generally provide for increased stiffness at both the front outer edge and the rear outer edge of the slat, with the edge stiffness being the same or similar along both edges of the slat. As such, the twice-folded configuration described herein allows for the inner core to be formed into a cellular structure having a symmetrical appearance with substantially equal stiffnesses along each outer edge.

Moreover, in several embodiments, the inner core may be configured to be positioned within the outer sock in a partially or fully detached state relative to the sock. Such a partially or fully detached state allows the inner core and outer sock to expand/contract relative to one another, thereby allowing any stresses causes by temperature fluctuations and other environmental conditions to be relieved. For instance, in one embodiment, the inner core may be completely detached from the outer sock such that the core is not coupled or connected to the sock at any location along an interface defined between such components, thereby allowing the inner core to freely move or expand/contract relative to the outer sock.

It should be understood that, as described herein, an “embodiment” (such as illustrated in the accompanying Figures) may refer to an illustrative representation of an environment or article or component in which a disclosed concept or feature may be provided or embodied, or to the representation of a manner in which just the concept or feature may be provided or embodied. However, such illustrated embodiments are to be understood as examples (unless otherwise stated), and other manners of embodying the described concepts or features, such as may be understood by one of ordinary skill in the art upon learning the concepts or features from the present disclosure, are within the scope of the disclosure. In addition, it will be appreciated that while the Figures may show one or more embodiments of concepts or features together in a single embodiment of an environment, article, or component incorporating such concepts or features, such concepts or features are to be understood (unless otherwise specified) as independent of and separate from one another and are shown together for the sake of convenience and without intent to limit to being present or used together. For instance, features illustrated or described as part of one embodiment can be used separately, or with another embodiment to yield a still further embodiment. Thus, it is intended that the present subject matter covers such modifications and variations as come within the scope of the appended claims and their equivalents.

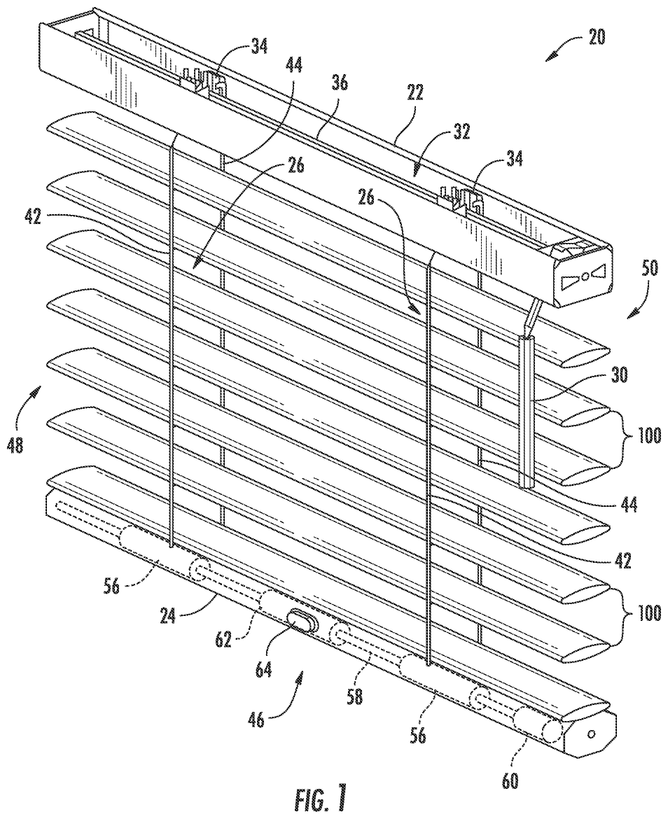

Referring now to the drawings, FIG. 1 illustrates a perspective view of one embodiment of a covering 20 for an architectural structure (not shown) in accordance with aspects of the present subject matter. In general, the covering 20 is configured to be installed relative to a window, door, or any other suitable architectural structure as may be desired. In one embodiment, the covering 20 may be configured to be mounted relative to an architectural structure to allow the covering 20 to be suspended or supported relative to the architectural structure. It should be understood that the covering 20 is not limited in its particular use as a window or door shade, and may be used in any application as a covering, partition, shade, and/or the like, relative to and/or within any type of architectural structure.

In several embodiments, the covering 20 may be configured as a slatted blind, such as a “privacy” Venetian-blind-type extendable/retractable covering. For example, in the embodiment shown in FIG. 1, the covering 20 includes a headrail 22, a bottom rail 24, and a plurality of horizontally disposed, parallel cellular slats 100 configured to be supported between the headrail 22 and the bottom rail 24 via one or more ladder tape assemblies 26 (e.g., a pair of ladder tape assemblies 26). In several embodiments, the cellular slats 100 are rotatable or tiltable about their longitudinal axes by manipulating the ladder tape assemblies 26 to allow the slats 100 to be tilted between a horizontal or open position (e.g., as shown in FIG. 1) for permitting light to pass between the slats 100 and a closed position (not shown), wherein the slats 100 are substantially vertically oriented in an overlapping manner to occlude or block the passage of light through the covering 20.

It should be appreciated that the ladder tape assemblies 26 may be manipulated to allow for the cellular slats 100 to be tilted between their open and closed positions using, for example, a suitable tilt wand 30 or any other suitable control device forming part of a tilt system 32 provided in operative association with the covering 20. For example, as shown in FIG. 1, the covering 20 includes one or more components of the tilt system 32 within the headrail 22, such as a tilt station 34 provided in operative association with each ladder tape assembly 26 and a tilt rod 36 coupled between the tilt wand 30 and the tilt stations 34. In such an embodiment, as the tilt wand 30 is manipulated by the user (e.g., by rotating the tilt wand 30 relative to the headrail 22), the tilt rod 36 may be rotated to rotationally drive one or more tilt drums (not shown) of the tilt stations 34, thereby allowing front and rear ladder rails (not shown) of each ladder tape assembly 26 to be raised or lowered relative to each other to adjust the tilt angle of the cellular slats 100.

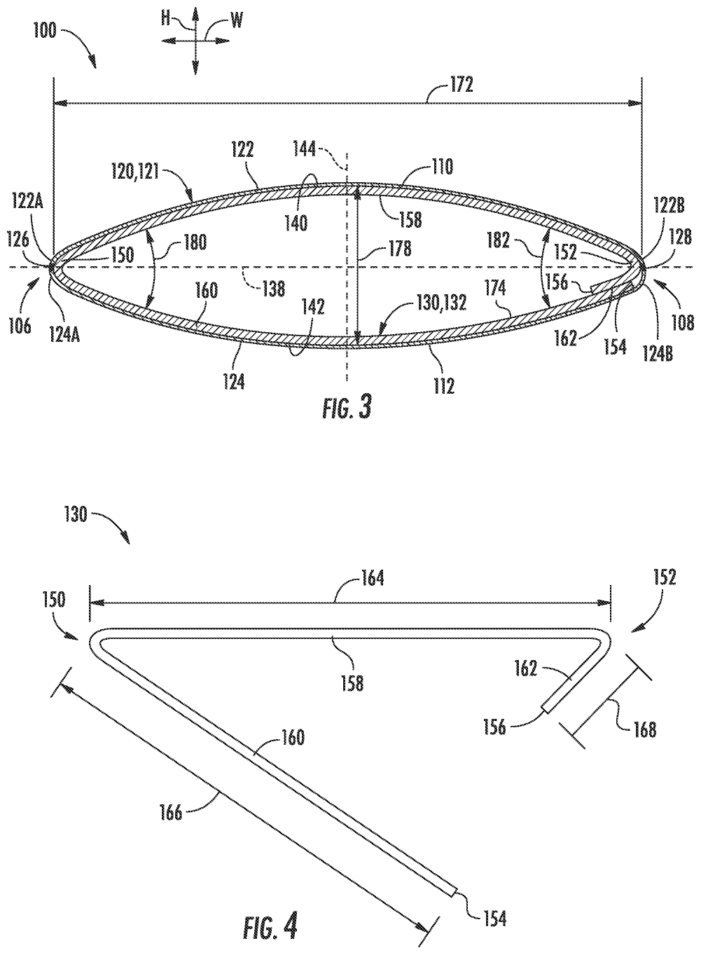

Moreover, as shown FIG. 1, the covering 20 also includes one or more pairs of lift cords 42, 44 forming part of a lift system 46 for moving the covering 20 between a lowered or extended position (e.g., as shown in FIG. 1) and a raised or retracted position (not shown). In the illustrated embodiment, the covering 20 includes two pairs of lift cords 42, 44 extending between the headrail 22 and the bottom rail 24. Each lift cord pair in FIG. 1 includes a front lift cord 42 extending along a front side 48 of the covering 20, and a rear lift cord 44 extending along a rear side 50 of the covering 20. Specifically, each front lift cord 42 is configured to extend between the headrail 22 and the bottom rail 24 along a front edge 106 (FIG. 3) of each cellular slat 100, while each rear lift cord 44 is configured to extend between the headrail 22 and the bottom rail 24 along an opposed rear edge 108 (FIG. 3) of each cellular slat 100.

In one embodiment, each pair of lift cords 42, 44 may be configured to extend to a corresponding lift station 56 to control the vertical positioning of the bottom rail 24 relative to the headrail 22. For instance, in the illustrated embodiment, each pair of lift cords 42, 44 is operatively coupled to a lift station 56 housed within the bottom rail 24. In such an embodiment, a bottom end (not shown) of each lift cord 42, 44 is configured to be coupled to its associated lift station 56 while an opposed end (not shown) of each lift cord 42, 44 is configured to be coupled to the headrail 22. For example, each lift station 56 may include one or more lift spools (e.g., a pair of lift spools) for winding and unwinding the respective lift cords 42, 44 of each pair of lift cords. Thus, as the bottom rail 24 is raised relative to the headrail 22, each lift cord 42, 44 is wound around its respective lift spool. Similarly, as the bottom rail 24 is lowered relative to the headrail 22, each lift cord 42, 44 is unwound from its respective lift spool. Additionally, the lift system 46 of the covering 20 may also include a lift rod 58 operatively coupled to the lift stations 56 and a spring motor 60 operatively coupled to the lift rod 58. In such an embodiment, as is generally understood, the spring motor 60 may be configured to store energy as the bottom rail 24 is lowered relative to the headrail 22 and release such energy when the bottom rail 24 is being raised relative to the headrail 22 to assist in moving the covering 20 to its retracted position.

It should be appreciated that, in one embodiment, the spring motor 60 may be overpowered. In such an embodiment, to prevent unintended motion of the bottom rail 24 relative to the headrail 22, a brake assembly 62 may be provided within the bottom rail 24 and may be operatively coupled to the lift rod 58 to stop rotation of the lift rod 58. For instance, as shown in FIG. 1, to actuate the brake assembly 62, an actuator button 64 is coupled to the bottom rail 24 that can be depressed to release or disengage the brake assembly 62 from the lift rod 58, thereby allowing the lift rod 58 to be rotated in a manner that permits the lift cords 42, 44 to be wound around or unwound from their respective lift spools as the bottom rail 24 is lowered or raised, respectively, relative to the headrail 22. In other embodiments, the spring motor 60 may not be overpowered, thereby eliminating the need for the brake assembly 62. For example, in one embodiment, the spring motor 60 may be adapted to provide a variable torque, thereby allowing the lift system 46 to be configured as a balanced operating system.

It should be appreciated that the configuration of the covering 20 described above and shown in FIG. 1 is provided only to place the present subject matter in an exemplary field of use. Thus, it should be apparent that the present subject matter may be readily adaptable to any suitable manner of covering configuration. For example, in other embodiments, the cellular slats 100 described herein may be configured for use within a vertical blind or covering in which the slats 100 are vertically orientated (as opposed to the horizontal orientation shown in FIG. 1). In such embodiments, the cellular slats 100 may, for instance, be suspended from a corresponding headrail or track to allow the slats to hang vertically therefrom relative to an adjacent architectural structure.

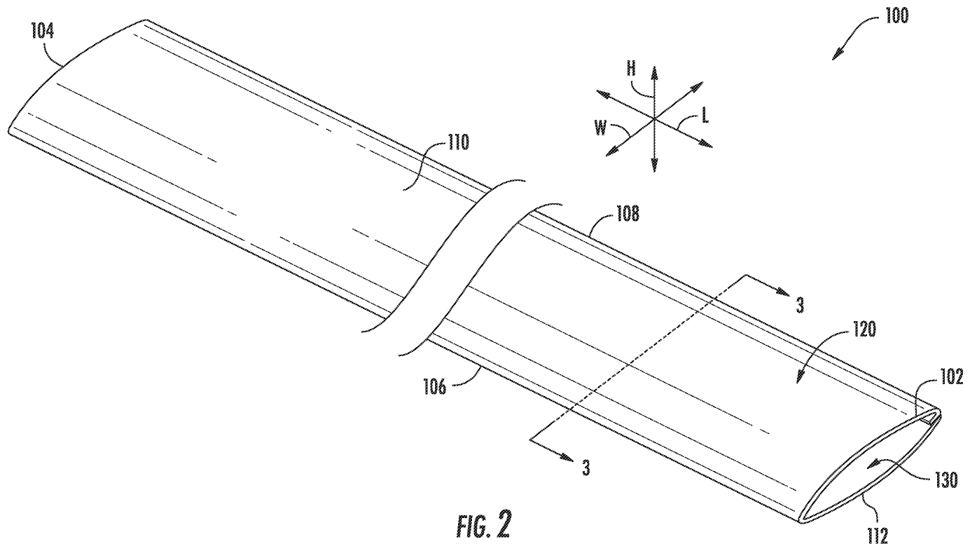

Referring now to FIGS. 2-4, different views of one embodiment of a cellular slat 100 are illustrated in accordance with aspects of the present subject matter. Specifically, FIG. 2 illustrates a perspective view of the cellular slat 100 and FIG. 3 illustrates a cross-sectional view of the slat 100 shown in FIG. 2 taken about line 3-3. Additionally, FIG. 4 illustrates an end view of an inner core 130 of the cellular slat 100 shown in FIGS. 2 and 3 in a non-constrained, disassembled state. It should be appreciated that, for purposes of description, the cellular slat 100 shown in FIGS. 2-4 will generally be described with reference to the covering 20 of FIG. 1. However, in general, the cellular slat 100 disclosed herein may be configured for use with coverings have any other suitable configuration, including any suitable horizontal and/or vertical coverings that incorporate or utilize slats as covering elements.

As particularly shown in FIG. 2, the cellular slat 100 generally extends in a longitudinal direction (as indicated by arrow L in FIG. 2) between a first lateral end 102 and a second lateral end 104 of the slat 100 and in a widthwise direction (as indicated by arrow W in FIGS. 2 and 3) between a front or first outer edge 106 and a rear or second outer edge 108 of the slat 100. In addition, the cellular slat 100 extends in a heightwise direction (as indicated by arrows H in FIGS. 2 and 3) between an upper or first outer face 110 and a lower or second outer face 112 of the slat 100, with the opposed outer faces 110, 112 extending in the widthwise direction W between the outer edges 106, 108 of the slat 100. As indicated above, when the cellular slat 100 is incorporated into a “privacy” Venetian-blind, the slat 100 may be configured to be vertically supported via one or more ladder tape assemblies 26 (e.g., via a rung(s) of each ladder tape assembly 26 extending along the second outer face 112 of the slat 100), with front and rear lift cords 42, 44 extending vertically along the opposed outer edges 106, 108 of the slat 100.

As particularly shown in FIG. 3, the cellular slat 100 includes both an outer sock 120 and an inner core 130 extending within the outer sock 120. In general, the outer sock 120 has a tube-like or looped configuration extending longitudinally along the entire length of the slat 100 (i.e., from the first lateral end 102 to the second lateral end 104 of the slat 100) that forms an outer cellular structure 121 of the slat 100 and, thus, defines the exterior features of the cellular slat 100. For instance, as shown in FIG. 3, the sock 120 generally forms a closed-perimeter cell along the outer perimeter of the slat 100 that defines the opposed outer faces 110, 112 and outer edges 106, 108 of the slat 100. In several embodiments, the outer sock 120 is formed from a flexible material. For instance, the outer sock 120 may be formed from a fabric material, such as a woven or non-woven fabric material. In one embodiment, the fabric material may be formed from thermoplastic fibers, such as polyester, nylon, or polyolefin fibers, or from any other suitable synthetic or natural fibers.

In one embodiment, to provide the tube-like or looped configuration of the outer sock 120, the sock 120 is formed from two separate strips of material (e.g., two separate strips of fabric material) that are joined together end-to-end at opposed seams or joints. Specifically, as shown in FIG. 3, the sock 120 is formed from first and second strips of material 122, 124 extending between the outer edges 106, 108 of the slat 100 such that the first strip of material 122 generally defines the first outer face 110 of the slat 100 and the second strip of material 124 generally defines the second outer face 112 of the slat 100. As shown in the illustrated embodiment, a first end 122A of the first strip of material 122 is coupled or connected to an adjacent first end 124A of the second strip of material 124 via a first joint 126 formed at the first outer edge 106 of the slat 100, while an opposed second end 122B of the first strip of material 122 is coupled or connected to the adjacent second end 124B of the second strip of material 124 via a second joint 128 formed at the second outer edge 108 of the slat 100. It should be appreciated that the joints 126, 128 provided between the adjacent ends of the strips of material 122, 124 may generally be formed using any suitable joining or connection means and/or methodology. For instance, in one embodiment, the adjacent ends of the material strips 122, 124 may be welded or bonded together using an ultrasonic sealing method to create ultrasonic slit/weld joints at the connection points between the strips 122, 124. Alternatively, the joints 126, 128 may correspond to lap joints at which the adjacent ends of the strips of material 122, 124 are overlapped and then coupled together using any suitable connection/coupling means (e.g., adhesives, stitching, sewing, tape, and/or the like).

In an accordance with aspects of the present subject matter, the outer sock 120 may be configured to constrain and envelop the inner core 130, with the core 130 functioning as a stiffening element to provide structural integrity to the cellular slat 100. However, while the outer sock 120 generally functions to constrain/contain the inner core 130, the core 130 is configured to be positioned within the outer sock 120 in a partially or completely detached state relative to the sock 120. Specifically, in several embodiments, when installed within the outer sock 120, the inner core 130 is configured to be detached from the outer sock 120 along at least a portion of an interface defined between the outer sock 120 and the inner core 130 (i.e., the interface defined between the inner perimeter of the sock 120 and the outer perimeter of the core 130). For example, in one embodiment, the inner core 130 may be completely detached from the outer sock 120 such that the core 130 is not coupled or connected to the sock 120 at any location along the interface defined between such components. In such an embodiment, the inner core 130 may be freely movable relative to the outer sock 120, which can be advantageous in instances in which the sock/core are formed from different materials having differing coefficients of thermal expansion. For instance, in embodiments in which the outer sock 120 is formed from a fabric material while the inner core 130 is formed from a polymer-based film material (as described below), the differing coefficients of thermal expansion of such materials would result in the sock 120 expanding/contracting at significantly different rates than the core 130, particularly at extreme temperatures. By providing the inner core 130 in a non-laminated, detached condition or state relative to the outer sock 120, such components can expand/contract relative to one another in a manner that allows any stresses causes by temperature fluctuations and other environmental conditions to be relieved, thereby eliminating the potential for any undesirable deformations, warping and/or other thermal or stress-related issues within the resulting cellular slat 100.

As an alternative to providing the inner core 130 in a completely detached state relative to outer sock 120, the inner core 130 may, instead, be only be provided in a partially detached state relative to the outer sock 120, such as a state in which the core 130 is attached or connected to the sock 120 along the interface defined between such components at one or more isolated locations. For instance, in one embodiment, the inner core 130 may be connected to the outer sock at a very localized region(s) or specific location(s) across interface defined between the sock 120 and the core 130 (e.g., via a localized glue bead(s) applied between the outer sock 120 and the inner core 130 that runs along the length of the slat 100 in the longitudinal direction L). Such a localized attachment point(s) may, for instance, provide a connection between the outer sock 120 and the inner core 130 while still allowing such components to expand/contract relative to one another to relieve any temperature-induced stresses.

Referring still to FIGS. 2-4, in several embodiments, the inner core 130 of the cellular slat 100 generally corresponds to a folded strip of material that is configured to form an inner cellular structure 132 within the interior of the sock 120 that provides stiffness and rigidity to the otherwise flexible sock 120. In addition, the inner cellular structure 132 formed by the inner core 130 also functions to create and maintain the desired shape of the cellular slat 100. For example, as will be described below, the inner core 130 may be folded or creased at spaced apart locations to provide two fold edges that form the opposed vertices of the inner cellular structure 132 (e.g., the vertices formed at the first and second fold edges 150, 152 shown in FIG. 3) when the core 130 is positioned within the sock 120. In such an embodiment, with the inner core 130 dimensionally constrained within the outer sock 120, the core 130 has a tendency to “spring-open” at the vertices or fold edges 150, 152 causing the core 130 to “puff-up” or expand outwardly in the heightwise direction H relative to an edge-to-edge or widthwise centerline 138 of the slat 100, thereby creating a cellular structure 132 having curved walls extending between the opposed vertices/folds 150, 152. As shown in FIG. 3, the opposed vertices/folds 150, 152 of the inner cellular structure 132 are generally positioned adjacent to and aligned with the outer edges 106, 108 of the cellular slat 100 (and, thus, the sock joints 126, 128 formed at the outer edges 106, 108) such that the curved walls of the cellular structure 132 generally extend parallel to and shape the outer faces 110, 112 of the cellular slat 100. With such positioning of the fold edges 150, 152, the slat 100 is generally provided with a uniform amount of edge stiffness at each of its outer edges 106, 108.

As shown in the illustrated embodiment, the inner cellular structure 132 formed by the core 130 defines a closed-perimeter or substantially closed-perimeter cell having a first curved profile along a first side 140 of the cellular structure 132 and a second curved profile along a second side 142 of the cellular structure 132, with the curved profiles generally extending in the widthwise direction W between the opposed vertices/folds 150, 152 of the cellular structure 132. The curved profiles are generally arced or curved outwardly such that the outer perimeter of the inner cellular structure 132 is characterized by opposed concave surfaces extending between the vertices/folds 150, 152, thereby providing the inner cellular structure 132 with a shape that is symmetrical or substantially symmetrical about the widthwise centerline 138 of the slat 100. Additionally, as shown in FIG. 3, due to the configuration of the inner core 130, the shape of the inner cellular structure 132 is also symmetrical or substantially symmetrical about a vertical or heightwise centerline 144 of the slat 100.

Referring briefly to FIG. 4, the general structure and configuration of the embodiment of the inner core 130 of the cellular slat shown in FIGS. 2 and 3 will now be described. It should be appreciated that the inner core 130 is shown in FIG. 4 in its non-constrained, disassembled state (i.e., relative to the outer sock 120). As will be described below, when the inner core 130 is positioned within the outer sock 120, the sock 120 dimensionally constrains the inner core 130, thereby allowing the core 130 to form the inner cellular structure 132 shown in FIG. 3.

As shown in FIG. 4, in several embodiments, the core 130 is formed from a flat strip of material that has been folded or creased at two spaced apart locations to form first and second fold edges 150, 152 disposed between opposed ends of the core 130 (e.g., first and second ends 154, 156 of the core 130). Such a twice-folded configuration generally divides the inner core 130 into three wall segments extending between/from the folds, with adjacent wall segments intersecting each other or otherwise being connected together at each fold edge 150, 152. Specifically, as shown in FIG. 4, the folded inner core 130 includes a central or base wall segment 158 extending directly between the first and second fold edges 150, 152. Additionally, the inner core 130 includes first and second folded wall segments 160, 162 extending from the base wall segment 158 at the first and second fold edges 150, 152, respectively, with the first folded wall segment 160 extending directly between the first fold edge 150 and the first end 154 of the inner core 130 and the second folded wall segment 162 extending directly between the second fold edge 152 and the second end 156 of the inner core 130. As shown, due to the relative positioning of the fold edges 150, 152 between the opposed ends 154, 156 of the inner core 130, the base wall segment 158 and the first folded wall segment 160 generally define substantially the same length (e.g., a base segment length 164 and a first folded segment length 166), while the second wall segment 162 defines a shorter length (e.g., a second folded segment length 168) than the other two wall segments 158, 160. However, in other embodiments, the various wall segments 158, 160, 162 may be configured to define any other suitable lengths relative to one another. For instance, in one embodiment, the second wall segment 162 may be configured to define the same or substantially the same length as the other two wall segments 158, 160.

In several embodiments, the inner core 130 is formed from a thin-walled material, such as a film material. For instance, in one embodiment, the inner core 130 may be formed from a polyester film, such as a biaxially oriented polyethylene terephthalate (PET) film (e.g., commercially available as MYLAR®). However, in other embodiments, the inner core 130 may be formed from other suitable film materials, such as various other suitable polymer-based film materials. In one embodiment, the specific film material used to form the inner core 130 may be selected based on the desired properties of the material, such as the tendency for the material to want to spring back towards an original flat or non-folded state upon being folded. Such a tendency facilitates the creation of the outward spring force at the fold edges 150, 152 when the inner core 130 is in its dimensionally constrained, assembled state within the outer sock 120. Additionally, in one embodiment, the film material used to form the inner core 130 may correspond to a commercially available pre-shrunk film material to prevent shrinkage issues or to otherwise provide dimensional stability to the material when exposed to extreme temperatures, particularly when exposure to a higher temperature range is anticipated.

In addition, a thickness of the film material may be selected to provide the desired structural integrity to the cellular slat 100 while also providing sufficient outward spring force at the fold edges 150, 152. For instance, in one embodiment, the thickness of the film material forming the inner core 130 may range from 0.002 inches to 0.010 inches, such as from 0.003 inches to 0.009 inches, or from 0.004 inches to 0.007 inches, and/or any other subranges therebetween. However, it should be appreciated that material thicknesses outside the thickness ranges described above may also be utilized, depending on the properties of the material being used to form the core 130 and/or the desired characteristics of the core 130 and/or the resulting cellular slat 100.

It should also be appreciated that the light transmissivity of the film material may also be varied to adjust the light-transmission characteristics of the cellular slat 100. For instance, in embodiments in which the outer sock 120 is being formed from a translucent material (e.g., a translucent fabric material), the inner core 130 may be formed from a clear film material to provide a translucent cellular slat 100. In another implementation using the same translucent material for the outer sock 120, the inner core 130 may be formed from a blackout film material (e.g., a film material formed from a vacuum metallization process that provides for little or no light transmission) to provide a blackout or room-darkening configuration for the cellular slat 100. Alternatively, the sock material may be used as the primary source for varying the light-transmission characteristics of the cellular slat 100. For instance, with the inner core 130 being formed from a clear film material, the outer sock 120 may be formed from a translucent material to provide a translucent cellular slat 100 or from a blackout material to provide a blackout or room-darkening cellular slat 100.

As shown in FIG. 4, each wall segment 158, 160, 162 of the inner core 130 generally defines a straight or non-curved profile along its length when the core 130 is in its non-constrained, disassembled state. However, with the core 130 positioned within the outer sock 120, the wall segments 158, 160, 162 take on the curved profiles of the inner cellular structure 132 described above. Specifically, referring back to FIG. 3, the base wall segment 158 of the inner core 130 generally defines the first curved profile extending along the first side 140 the inner cellular structure 132, while the first folded wall segment 160 generally defines the second curved profile extending along the second side 142 of the inner cellular structure 132. As indicated above, such curving or arcing of the wall segments 158, 160 generally occurs as a result of the outward spring force provided via the fold edges 150, 152 when the core 130 is dimensionally constrained within the outer sock 120. For example, in one embodiment, the segment lengths 164, 166 (FIG. 4) of the base wall segment 158 and the first folded wall segment 160 may be greater than an inner width 172 (FIG. 3) of the outer cellular structure 121 defined by the outer sock 120 in the widthwise direction W. As such, with the inner core 130 positioned within the outer sock 120, the sock 120 may dimensionally constrain the core 130 in the widthwise direction W, thereby causing the base wall segment 158 and the first folded wall segment 160 to transition into the outwardly curved profiles via the spring force provided at the fold edges 150, 152.

Referring still to FIG. 3, as indicated above, the base wall segment 158 of the inner core 130 generally defines the first curved profile of the inner cellular structure 132, while the first folded wall segment 160 generally defines the second curved profile of the inner cellular structure 132. Specifically, the base wall segment 158 defines the curved profile extending along the first side 140 of the inner cellular structure 132 between the first and second vertices/folds 150, 152 of the inner cellular structure 132. Similarly, the first folded wall segment 160 defines the curved profile extending along the second side 142 of the inner cellular structure 132 between the first and second vertices/folds 150, 152 of the inner cellular structure 132. In this regard, it should be noted that the first folded wall segment 160 generally extends along the entire width of the inner cellular structure 132 from the first vertex or fold edge 150 to the second vertex or fold edge 152, with the first folded wall segment 160 terminating at or adjacent to the second fold edge 152. Specifically, as shown in FIG. 3, the first end 154 of the inner core 130 (which also forms the end of the first folded wall segment 160 opposite the first fold edge 150) is generally positioned adjacent to the second fold edge 152. Thus, with the inner core 130 dimensionally constrained within the outer sock 120, both the base wall segment 158 and the first folded wall segment 160 generally extend substantially across the entire inner width of the outer cellular structure 121 formed by the sock 120.

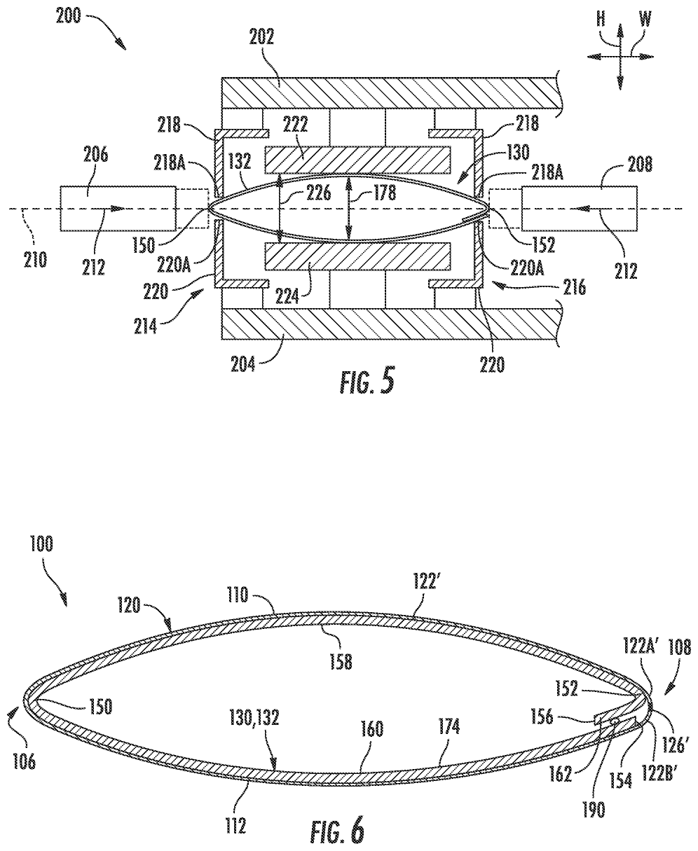

Additionally, as shown in FIG. 3, the first and second folded wall segments 160, 162 are generally configured to at least partially overlap each other when the core 130 is formed into the inner cellular structure 132. Specifically, the second folded wall segment 162 of the inner core 130 is generally configured to overlap the first folded wall segment 160 along a portion of the second side 142 of the inner cellular structure 132. For example, as shown in FIG. 3, the second folded wall segment 162 generally extends from the second vertex or fold edge 152 into an interior of the inner cellular structure 132 along an inner surface 174 of the first folded wall segment 160 so that the folded wall segments 160, 162 overlap each other along a given overlapped region. In one embodiment, the second folded wall segment 162 may simply extend along the inner surface 174 of the first folded wall segment 160 without being coupled to such wall segment 160 at any point across the overlapped region. In such an embodiment, the dimensional constraint provided to the inner core 130 by the outer sock 120 may function to maintain the first and second folded wall segments 160, 162 in their overlapped state or condition, as well as to generally maintain the inner core 130 in its cellular configuration. Alternatively, as will be described below with reference to the slat embodiment shown in FIG. 6, the first and second folded wall segments 160, 162 may, instead, be coupled together at the location of the overlap defined therebetween, thereby providing a lap joint or connection between the folded wall segments 160, 162 that can maintain the cellular configuration of the inner core 130 independent of the outer sock 120.

As indicated above, the second folded wall segment 162 may be configured to define a segment length 168 that is shorter than the lengths 164, 166 of the other wall segments 158, 160 of the inner core 130. However, it should be appreciated that, in general, the overall length 168 of the second folded wall segment 162 (and the length of associated overlapped region defined between first and second folded wall segments 160, 162) may be selected such that the length 168 is, at a minimum, sufficient to allow the same or similar outward spring force to be exerted at the second fold edge 152 as that exerted at the first fold edge 150, thereby allowing the core 130 to uniformly “puff-out” or expand outwardly in the heightwise direction H across the width of the slat 100 to form the symmetrically curved inner cellular structure 132 disclosed herein. For instance, in one embodiment, the length 168 of the second folded segment 162 may be equal to or greater than 0.25 inches, such as a length ranging from 0.25 inches to 1 inch or from 0.25 inches to 0.5 inches and/or any other subranges therebetween. In other embodiments, depending on the overall size of the slat 100, the length 168 of the second folded wall segment 162 may be less than or greater than the above-referenced length range, including being the same or substantially the same as the lengths 164, 166 of the other wall segments 158, 160 of the inner core 130. For example, in one alternative embodiment, the length 168 of the second folded wall segment 162 may be selected such that the wall segment 162 extends along or overlaps the inner surface 174 of the first folded wall segment 160 from the second fold edge 152 to a location at or adjacent to the first fold edge 150.

As shown in FIG. 3, with the inner core 130 positioned within the outer sock 120, the inner cellular structure 132 defines a cell height 178 in the heightwise direction H between the opposed first and second sides 140, 142 of the inner cellular structure 132 that is generally a function of an inner cell angle formed at each of the vertices or fold edges 150, 152 of the inner core 130 (e.g., a first inner cell angle 180 and a second inner cell angle 182). Specifically, the height 178 of the inner cellular structure 132 is generally proportional to the magnitude of inner cell angles 180, 182, with the cell height 178 generally increasing with increases in the inner cell angles 180, 182 (and vice versa). As such, the inner cell angle 180, 182 defined at each vertex or fold edge 150, 152 may generally be selected to provide the desired cell height 178 and, thus, the desired overall shape of the resulting cellular slat 100. For instance, in one embodiment, each of the inner cell angles 180, 182 may correspond to an angle ranging from 10 degrees to 35 degrees, such as from 15 degrees to 30 degrees or from 20 degrees to 25 degrees and/or any other subranges therebetween. It should be appreciated that, in one embodiment, the inner cell angle 180 formed at the first vertex or fold edge 150 may be the same as or substantially the same as the inner cell angle 182 formed at the second vertex or fold edge 152. However, in other embodiments, the first and second inner cell angles 180, 182 may correspond to different angles, such as when different inner cell angles are needed to achieve the desired shape for the cellular slat 100 (e.g., a desired symmetrical shape). For instance, depending on the thickness of the material used to form the inner core 130, the second inner cell angle 182 may need to be slightly smaller than the first inner cell angle 180 to provide a symmetrical cell shape given the overlap between the first and second folded wall segments 160, 162 at the second vertex or fold edge 152.

In certain instances, the folds formed in the inner core 130 at the fold edges 150, 152 may be subject to destabilization when the core 130 is exposed to higher temperatures, thereby causing the inner cell angles 180, 182 of the inner cellular structure 132 to increase as the folds expand outwardly towards an unfolded or straightened state. For instance, depending on the particular film material used to form the inner core 130, it is possible for the folds formed in the core 130 to destabilize or expand outwardly with exposure to the typical range of high-end temperatures found in window environments (e.g., 120 to 170 degrees Fahrenheit). Such expansion of the folds will result in the inner cellular structure 132 “puffing up” in the heightwise direction H as the cell height 178 increases, which can lead to an undesirable overall shape or profile for the cellular slat 100. Accordingly, to prevent or minimize expansion or destabilization of the folds, all or a portion of the material forming the inner core 130 can be heated to a suitable temperature to heat-set or heat stabilize the material at higher temperatures. For instance, in accordance with aspects of the present subject matter, the folds formed at the fold edges 150, 152 of the inner core 1430 may be heat-set or heat-stabilized by heating the material forming the inner core 130 only at the locations of the fold edges 150, 152. Such localized heating provides an effective means for heat-setting or heat-stabilizing the folds without requiring the entirety of the inner core 130 to be subject to a heat treatment process.

For example, FIG. 5 illustrates a cross-sectional view of a heat treatment apparatus or assembly 200 that allows for the folds of the inner core 130 to be heat-set or heat-stabilized (e.g. during an in-line slat manufacturing process). As shown, the assembly 200 includes first and second outer support plates 202, 204 spaced apart from one another such that the inner core 130 (e.g., as formed into the inner cellular structure 132) can be supported between the support plates 202, 204 in a manner that allows the vertices or fold edges 150, 152 of the core 130 to be heat treated via heated elements (e.g., first and second heated bars 206, 208) positioned along opposite sides of the core 130. Specifically, in one embodiment, the heated bars 206, 208 may be actuatable (e.g., along a widthwise centerline 210 of the assembly 200) towards the inner core 130 (e.g., as indicated by arrows 212) to move each heated bar 206, 208 into contact with the adjacent fold edge 150, 152 of the inner core 130 for a sufficient period of time to allow the core material at each fold edge 150, 152 to be heated to a suitable temperature for heat-setting or heat-stabilizing the material (e.g., to a temperature above the glass transition temperature for the material). For instance, in one embodiment, the heated bars 206, 208 may be heated to a temperature above 250 degrees Fahrenheit (° F.), such as a temperature ranging from about 300° F. to about 450° F. or from about 360° F. to about 400° F., and moved into contact with the fold edges 150, 152 of the inner core 130 for a period of less than 2 seconds, such as a time period ranging from about second to about 1.5 seconds or from about 0.5 seconds to about 1 second, to provide sufficient heating to heat-set or heat-stabilize the material. However, it should be appreciated that, in other embodiments, the specific temperature of the heated bars 206, 208 and/or the specific heating time may vary depending on the material used to form the inner core 130.

It should be appreciated that, although only a single pair of heated elements are shown in FIG. 5 (e.g., the pair of heated bars 206, 208), the heat treatment assembly 200 may include two or more pairs of the heated elements positioned along the processing direction of the inner core 130 (e.g., a direction into and out of the page). For instance, when the inner core 130 is being moved through the heat treatment assembly 200 in the processing direction as part of an in-line slat manufacturing process, the different pairs of heated elements may be sequentially actuated to heat the fold edges 150, 152 as the inner core 130 passes thereby. It should also be appreciated that, in certain instances, it may be desirable to cool the fold edges 150, 152 of the inner core 130 immediately following the heat treatment process. For instance, when the heat treatment process is part of in-line slat manufacturing process, cooling elements (e.g., cooling bars) or any other suitable cooling means may be provided immediately downstream of the heat treatment assembly 200 to allow the fold edges 150, 152 to be cooled prior to any further downstream processing of the inner core 130.

As shown in FIG. 5, to support the inner core 130 in position relative to the heated bars 206, 208 during the heat treatment process, the assembly 200 may also include a pair of edge guides (e.g., first and second edge guides 214, 216) positioned between the outer support plates 202, 204. Specifically, as shown in the illustrated embodiment, each edge guide 214, 216 includes an upper edge guide member 218 coupled to and supported by the first outer support plate 202 and a lower edge guide member 220 coupled to and supported by the second outer support plate 204. Each edge guide member 218, 220 generally extends inwardly from its respective support plate 202, 204 towards the centerline 210 of the assembly 200 and terminates at an inner end of the edge guide member 218, 220, with the inner end 218A of each upper edge guide member 218 being spaced apart from the inner end 220A of the adjacent lower edge guide member 220 of the respective edge guide 214, 216 such that a gap is defined between the edge guide members 218, 220 for receiving the vertices or fold edges 150, 152 of the inner core 130. As such, the edge guides 214, 216 may function to restrict movement of the inner core 130 in the widthwise direction W, thereby maintaining the core 130 generally centered within the assembly 200.

Additionally, as shown in FIG. 5, the heat treatment assembly 200 may also include a pair of height control plates (e.g., upper and lower height control plates 222, 224) positioned between the outer support plates 202, 204 that are configured to constrain or limit outward movement of the inner core 130 in the heightwise direction H during the heat treatment process. Specifically, as the heated bars 206, 208 are pressed into the inner core 130, the inwardly-directed pressure applied by the heated bars 206, 208 at the fold edges 150, 152 would otherwise tend to force the core 130 to “puff-up” or expand outwardly in the heightwise direction H as the folds expand within movement of the fold edges 150, 152 inwardly towards each other. However, by providing the height control plates 222, 224 along either side of the inner core 130, such expansion of the core 130 in the heightwise direction H is limited. In one embodiment, each height control plate 222, 224 may be adjustably mounted to its respective support plate 202, 204 to allow the plates 224, 224 to be moved closer to or further away from one another in the heightwise direction H to adjust the height of a heightwise gap 226 defined between the plates to the desired cell height 178 for the inner cellular structure 132 formed by the inner core 130. As indicated above, an interdependent relationship generally exists between the cell height 178 and the inner cell angles 180, 182 (FIG. 3) defined at the fold edges 150, 152 of the inner cellular structure 132. Thus, by using the height control plates 222, 224 to limit the heightwise expansion of the inner cellular structure 132 to the desired cell height 178 for such structure, the core material located at the fold edges 150, 152 may be heat-set or heat-stabilized at the desired cell angle 180, 182. As a result, when the inner core 130 is assembled within the outer sock 120 to form a cellular slat 100, the desired shape of the slat 100 (e.g., including the desired cell angle 180, 182 and cell height 178) can be maintained at high-end temperatures due to the material being heat-set or heat-stabilized at the fold edges 150, 152.

It should be appreciated that both the edge guides 214, 216 and the height control plates 222, 224 may generally function to maintain the inner core 130 in its cellular configuration during the heat treatment process. Specifically, the dimensional constraints provided by the edge guides 214, 216 (e.g., in the widthwise direction W) and the height control plates 222, 224 (e.g., in the heightwise direction H) may generally retain the inner cellular structure 132 formed by inner core 130 in the desired shape while the inner core 130 is being heat treated. Such dimensional constraint is particularly useful in embodiments in which the overlapped wall segments 160, 162 (FIG. 3) of the inner core 130 are not coupled together via a joint or seam (e.g., as described above with reference to FIG. 3).

Referring now to FIG. 6, a cross-sectional view of another embodiment of the cellular slat 100 described above with reference to FIGS. 2-4 is illustrated in accordance with aspects of the present subject matter, particularly illustrating alternative configurations for the outer sock 120 and the inner core 130 of the cellular slat 100. It should be appreciated that, except as described below, the outer sock 120 and inner core 130 shown in FIG. 6 may generally be configured the same as or similar to that described above with reference to FIGS. 2-4.

As shown in FIG. 6, unlike the two-piece sock configuration described above with reference to FIG. 3, the outer sock 120 is formed from a single strip of material 122′ (e.g., a strip of fabric material) that has been placed in a looped arrangement and coupled end-to-end at a single joint to form the tube-like configuration of the sock 120. Specifically, in the illustrated embodiment, a first end 122A′ of the strip of material 122′ is coupled or connected to the opposed end 122B′ of the strip of material 122′ via a sock joint 126′ formed at one of the outer edges 106, 108 of the slat 100 (e.g., the second outer edge 108 of the slat 100). It should be appreciated that, similar to the embodiment described above, the joint 126′ provided between the adjacent ends of the strip of material 122′ may generally be formed using any suitable joining or connection means and/or methodology. For instance, in one embodiment, the ends of the material strip 122′ may be welded or bonded together using an ultrasonic sealing method to create an ultrasonic slit/weld joint. Alternatively, the joint 126′ may correspond to a lap joint at which the ends of the material strip 122′ are overlapped and then coupled together using any suitable connection/coupling means (e.g., adhesives, stitching, sewing, tape, and/or the like).

Additionally, unlike the arrangement of the inner core 130 described above with reference to FIG. 3 that includes overlapped, but unattached folded wall segments, the first and second folded wall segments 160, 162 of the inner core 130 shown in FIG. 6 are coupled together at the location of the overlap defined between such components. By connecting the folded wall segments 160, 162 together in this manner, the inner core 130 may be configured to be maintained in its cellular configuration independent of the outer sock 120. As shown in the illustrated embodiment, a lap joint may be formed via application of an adhesive (e.g., a glue bead 190) at the overlapped interface defined between the first and second folded wall segments 160, 162. Alternatively, any other suitable connection/joining means or methodology (e.g., tape, welding, etc.) may be used to form the lap joint between the folded wall segments 160, 162.

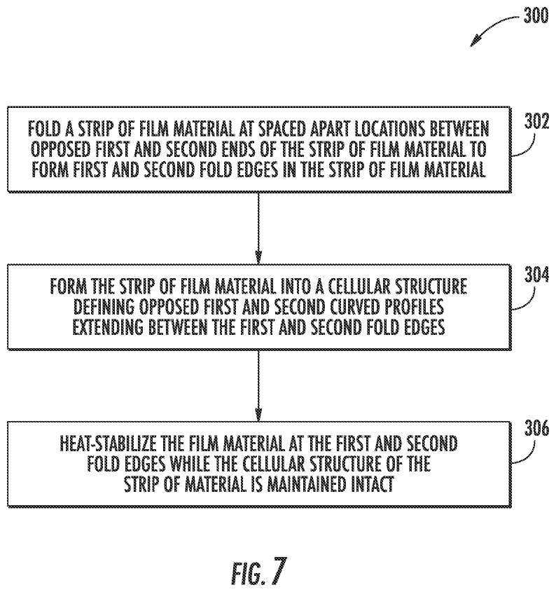

It should be appreciated that, in several embodiments, the present subject matter is also directed to a method for manufacturing inner core structures configured for use within cellular slats. For example, FIG. 7 illustrates a flow diagram of one embodiment of a method 300 for manufacturing inner core structures configured for use within cellular slats. For purposes of discussion, the method 300 will generally be described herein with reference to the inner core 130 of the cellular slat 100 described above with reference to FIGS. 1-4 and 6, as well as the heat treatment assembly 200 described above with reference to FIG. 5. However, it should be appreciated that the disclosed method 300 may generally be used to manufacture inner core structures configured for use with cellular slats having any other suitable slat configuration and/or using heat treatment assemblies have any other suitable configuration. Additionally, although FIG. 7 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 7, at (302), the method 300 includes folding a strip of film material at spaced apart locations between opposed first and second ends of the film material to form first and second fold edges in the strip of film material. For instance, as indicated above, a straight or non-folded strip of film material used to form an inner core 130 may be folded at a first location to form a first fold edge 150 and at a second location to form a second fold edge 152, with the first and second fold edges 150, 152 being spaced apart from opposed ends 154, 156 of the film material strip such that the inner core 130 is divided into three wall segments 158, 160, 162.

Additionally, at (304), the method 300 includes forming the strip of film material into a cellular structure defining opposed first and second curved profiles extending between the first and second fold edges. For instance, as described above, the folded strip of film material may be formed into a closed-perimeter or substantially closed-perimeter cell having a first curved profile extending along a first side 140 of the cellular structure 132 (e.g., as defined by the base wall segment 158 of the inner core 130) and a second curved profile along a second side 142 of the cellular structure 132 (e.g., as defined by the first folded wall segment 160 of the inner core 130).

Moreover, at (306), the method 300 includes heat-stabilizing the film material at the first and second fold edges while the cellular structure of the strip of material is maintained intact. Specifically, as indicated above, the inner core 130 (as formed into the inner cellular structure 132) may be positioned within a heat treatment assembly 200 that allows the film material forming the inner core 130 to be heat-set or heat-stabilized at the fold edges 150, 152 (e.g., using the heated elements). As described above, it should be appreciated that, when the overlapped wall segments 160, 162 of the inner core 130 are not connected together (e.g., as in the embodiment shown in FIG. 3), the dimensional constraints provided via the heat treatment assembly 200 (e.g., the edge guides 214, 216 and the height control plates 222, 224 of the heat treatment assembly 200) may be used to maintain the cellular configuration of the inner core 130 intact during the heat treatment process.

While the foregoing Detailed Description and drawings represent various embodiments, it will be understood that various additions, modifications, and substitutions may be made therein without departing from the spirit and scope of the present subject matter. Each example is provided by way of explanation without intent to limit the broad concepts of the present subject matter. In particular, it will be clear to those skilled in the art that principles of the present disclosure may be embodied in other forms, structures, arrangements, proportions, and with other elements, materials, and components, without departing from the spirit or essential characteristics thereof. For instance, features illustrated or described as part of one embodiment can be used with another embodiment to yield a still further embodiment. Thus, it is intended that the present subject matter covers such modifications and variations as come within the scope of the appended claims and their equivalents. One skilled in the art will appreciate that the disclosure may be used with many modifications of structure, arrangement, proportions, materials, and components and otherwise, used in the practice of the disclosure, which are particularly adapted to specific environments and operative requirements without departing from the principles of the present subject matter. For example, elements shown as integrally formed may be constructed of multiple parts or elements shown as multiple parts may be integrally formed, the operation of elements may be reversed or otherwise varied, the size or dimensions of the elements may be varied. The presently disclosed embodiments are therefore to be considered in all respects as illustrative and not restrictive, the scope of the present subject matter being indicated by the appended claims, and not limited to the foregoing description.

In the foregoing Detailed Description, it will be appreciated that the phrases “at least one”, “one or more”, and “and/or”, as used herein, are open-ended expressions that are both conjunctive and disjunctive in operation. The term “a” or “an” element, as used herein, refers to one or more of that element. As such, the terms “a” (or “an”), “one or more” and “at least one” can be used interchangeably herein. All directional references (e.g., proximal, distal, upper, lower, upward, downward, left, right, lateral, longitudinal, front, rear, top, bottom, above, below, vertical, horizontal, cross-wise, radial, axial, clockwise, counterclockwise, and/or the like) are only used for identification purposes to aid the reader's understanding of the present subject matter, and/or serve to distinguish regions of the associated elements from one another, and do not limit the associated element, particularly as to the position, orientation, or use of the present subject matter. Connection references (e.g., attached, coupled, connected, joined, secured, mounted and/or the like) are to be construed broadly and may include intermediate members between a collection of elements and relative movement between elements unless otherwise indicated. As such, connection references do not necessarily infer that two elements are directly connected and in fixed relation to each other. Identification references (e.g., primary, secondary, first, second, third, fourth, etc.) are not intended to connote importance or priority, but are used to distinguish one feature from another.

All apparatuses and methods disclosed herein are examples of apparatuses and/or methods implemented in accordance with one or more principles of the present subject matter. These examples are not the only way to implement these principles but are merely examples. Thus, references to elements or structures or features in the drawings must be appreciated as references to examples of embodiments of the present subject matter, and should not be understood as limiting the disclosure to the specific elements, structures, or features illustrated. Other examples of manners of implementing the disclosed principles will occur to a person of ordinary skill in the art upon reading this disclosure.

This written description uses examples to disclose the present subject matter, including the best mode, and also to enable any person skilled in the art to practice the present subject matter, including making and using any devices or systems and performing any incorporated methods. The patentable scope of the present subject matter is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

The following claims are hereby incorporated into this Detailed Description by this reference, with each claim standing on its own as a separate embodiment of the present disclosure. In the claims, the term “comprises/comprising” does not exclude the presence of other elements or steps. Furthermore, although individually listed, a plurality of means, elements or method steps may be implemented by, e.g., a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second”, etc., do not preclude a plurality. Reference signs in the claims are provided merely as a clarifying example and shall not be construed as limiting the scope of the claims in any way.

1. A cellular slat for a covering for an architectural structure, the cellular slat comprising:
an outer sock forming an outer cellular structure;
an inner core configured to be positioned within the outer cellular structure of the outer sock, the inner core comprising first and second ends and first and second fold edges formed between the first and second ends such that the inner core includes a plurality of wall segments, the plurality of wall segments comprising a base wall segment extending between the first and second fold edges of the inner core, a first folded wall segment extending between the first fold edge of the inner core and first end of the inner core, and a second folded wall segment extending between the second fold edge of the inner core and the second end of the inner core;
wherein:
with the inner core positioned within the outer sock, the inner core forms an inner cellular structure having opposed first and second sides extending between the first and second fold edges of the inner core;
the inner cellular structure has a first curved profile defined by the base wall segment that extends along the first side of the cellular structure and a second curved profile defined by at least one of the first folded wall segment or the second folded wall segment that extends along the second side of the cellular structure; and
the inner core is in an at least partially detached state relative to the outer sock along at least a portion of an interface defined between the inner core and the outer sock.

2. The cellular slat of claim 1, wherein the at least partially detached state of the inner core allows for relative movement between the inner core and the outer sock.

3. The cellular slat of claim 1, wherein the inner core is completely detached from the outer sock along the interface defined between the inner core and the outer sock.

4. The cellular slat of claim 1, wherein, with the inner core positioned within the outer sock, a spring force is generated at the first and second fold edges that forces the first and second sides of the inner cellular structure away from each other to form the first and second curved profiles, respectively.

5. The cellular slat of claim 1, wherein a material forming the inner core is heat-stabilized at the first and second fold edges.

6. The cellular slat of claim 1, wherein:
the inner cell structure extends in a widthwise direction between the first and second fold edges and in a heightwise direction between the first and second sides of the inner cell structure;
the outer cell structure of the outer dock defines an inner cell width in the widthwise direction; and
the base wall segment and the first folded wall segment of the inner core each define a segment length that is greater than the inner cell width of the outer cell structure.

7. (canceled)

8. The cellular slat of claim 1, wherein:
the second curved profile is defined by the first folded wall segment of the inner core; and
the second folded wall segment of the inner core extends within an interior of the inner cell structure adjacent to an inner surface of the first folded wall segment.

9. The cellular slat of claim 1, wherein the first and second folded wall segments at least partially overlap each other along the second side of the cellular structure.

10. The cellular slat of claim 9, wherein the first and second folded wall segments are coupled together via a lap joint formed at a location of the overlap defined between the first and second folded wall segments.

11. The cellular slat of claim 1, wherein the outer sock comprises at least one strip of material provided in a looped configuration via at least one joint to form the outer cellular structure.

12. The cellular slat of claim 11, wherein:
the at least one strip of material comprises a looped strip of material and the at least one joint comprises a sock joint; and
the looped strip of material includes opposed ends coupled together at the sock joint to form the outer cellular structure.

13. (canceled)

14. The cellular slat of claim 11, wherein:
the at least one strip of material comprises first and second strips of material and the at least one joint comprises first and second sock joints; and
adjacent ends of the first and second strips of materials are coupled together at the first and second sock joints to form the outer cellular structure.

15. (canceled)

16. (canceled)

17. The cellular slat of claim 1, wherein the inner core is formed from a film material.

18. (canceled)

19. (canceled)

20. The cellular slat of claim 17, wherein the film material comprises a clear film material or a blackout film material

21. (canceled)

22. The cellular slat of claim 1, wherein a shape of the inner cellular structure formed by the inner core is symmetrical or substantially symmetrical about at least one centerline of the cellular slat.

23. A covering for an architectural structure including a plurality of cellular slats, with each cellular slat of the plurality of cellular slats being configured in accordance with the cellular slat of claim 1.

24. (canceled)

25. A method for manufacturing inner core structures configured for use within cellular slats, the method comprising:
folding a strip of film material at spaced apart locations between opposed first and second ends of the film material to form first and second fold edges in the strip of film material;
forming the strip of film material into a cellular structure defining opposed first and second curved profiles extending between the first and second fold edges; and
heat-stabilizing the film material at the first and second fold edges while the cellular structure of the strip of material is maintained intact.

26. The method of claim 25, wherein forming the strip of film material into the cellular structure comprises forming the strip of film material into the cellular structure such that the first curved profile extends along a first side of the cellular structure and the second curved profile extends along a second side of the cellular structure, with the first and second fold edges forming opposed vertices of the cellular structure.

27. The method of claim 25, wherein heat-stabilizing the film material at the first and second fold edges comprises contacting the first and second fold edges with heated elements for a period of time.

28. The method of claim 27, wherein:
the first curved profile extends along a first side of the cellular structure and the second curved profile extends along a second side of the cellular structure, with the first and second sides being spaced apart from each other in a heightwise direction of the cellular structure; and
contacting the first and second fold edges with the heated elements comprises pressing the heating elements into the first and second fold edges while the first and second sides of the cellular structure are constrained against movement away from each other in the heightwise direction.
